(19) United States
(12) Patent Application Publication
(10) Pub. No.: US 2007/0196678 A1
(43) Pub. Date: Aug. 23, 2007

(54) Multilayered sheet and method of making same

(76) Inventors: Jack Graham, De Forest, WI (US); David P. Dumbleton, Madison, WI (US)

Correspondence Address: SCHWARTZ COOPER CHARTERED;IP DEPARTMENT, 180 NORTH LASALLE STREET, SUITE 2700, CHICAGO, IL, 60601, US

(21) Appl. No.: 11/704,053

(22) Filed: Feb. 8, 2007

Related U.S. Application Data
(60) Provisional application No. 60/771,289, filed on Feb. 8, 2006.

(51) Int. Cl. B29C 67/20; B32B 27/08

(52) U.S. Cl. 428/517; 264/175; 264/171.1; 428/515; 428/516; 428/519

(57) ABSTRACT

A multilayered sheet (10) is made by extruding a sheet (20) and bringing it into immediate contact with a non-woven sheet (40) before bringing the abutting sheets into a first nip (201) formed by a pair of pressure rollers (121,122). The multilayered sheet (10) then passes through a second nip (202) formed between two pressure rollers (122,123) and is cooled down through a series of additional chill rollers (123,124,125,126).

### CROSS REFERENCE TO RELATED APPLICATIONS

This Application claims priority on pending U.S. Provisional Application No. 60/771,289 filed on Feb. 8, 2006, which is herein incorporated by reference.

### TECHNICAL FIELD

The present invention relates to a multilayered sheet and more particularly, to a sheet constructed of at least two materials melded during construction thereof to form a resilient and flexible plastic sheet with a relatively soft side for use in packaging to protect and/or separate goods during transportation or storage. Other uses are also disclosed. The invention also is to the method of making the multi-layered sheet.

### BACKGROUND OF THE INVENTION

Fragile, precision items and/or specialized items are specially packaged to ensure they are not damaged during packing, unpacking, transporting and storing. Often times, customized dunnage is used to both hold and prevent the product, e.g., items or pieces, from moving or being injured. In addition, packing sheets can be used, such as between products or wrapped around products, to ensure separation between the products and to prevent movement of and injury to the products. Such sheets often require the characteristics of being rigid, flexible and yet soft. The rigid, flexible structure is frequently important to withstand the forces caused by the product and movement of the package. Softness is important to prevent marring of the product if it rubs against the sheet. These sheets should further be robust with a long lifespan, wherein the sheet can be used over and over without degradation. Finally, it is often important to have a low weight sheet to keep the overall weight of the package as low as possible.

This packing or separation sheets are also used in trunks as linings to protect or separate items, such as a spare tire or in luggage to separate compartments.

Packing/separation sheets can be made from plastic, such as polypropylene. It has been found that non-woven, spun-bound polypropylene works well as a surface for packing sheets. This material is well suited for packaging as spacers, dunnage and separators primarily because it can act as a cushion and does not scratch or mar surfaces. However, the non-woven, spunbond sheets do not generally have the strength or integrity alone to act in some packing environments and as separator sheets. As such, such sheets must be bound to a carrier substrate, such as a sheet of polypropylene, to give it strength.

Multi-layered sheets such as those discussed above generally incorporate adhesives to bond the layers to one another. This affects recyclability since the use of the adhesive makes the lamination undesirable as a recyclable. In addition, using an adhesive increases the costs of making the product, due to the extra equipment to incorporate the adhesive and due to the cost of the adhesive.

### SUMMARY OF THE INVENTION

The present development solves the problems discussed above and other problems, and provides advantages and aspects not provided by prior multilayered sheets used in packaging and as dividers. A multilayer sheet is formed by the lamination process wherein an extruded sheet is pressed against a non-woven sheet downstream from the die of the extruder and just prior to the first nip formed by confronting chill rollers. The combined sheet is passed through a second nip and a series a chill rollers before it is wound. The extruded sheet can be substantially solid or extruded corrugated plastic.

According to a first aspect of the present invention, a multilayered sheet is disclosed having both strength and softness. The sheet includes a preformed first sheet and a second sheet laminated to the first sheet, the second sheet being extruded onto the first sheet before both sheets are passed through a nip formed by confronting rollers. The preformed sheet is a non-woven, spunbond polypropylene having a thickness of about 0.010″ and the second sheet is a polypropylene having a thickness of about 0.020″ to 0.050″.

According to a second aspect of the present invention, the method of making the multilayered sheet comprises the steps of feeding a preformed sheet to a nip so that the sheet passes therethrough, and extruding a second sheet onto the preformed sheet before the preformed sheet passes through the nip to form a multilayered sheet. The preformed sheet is a non-woven spunbond polypropylene sheet and the second, extruded sheet is a polypropylene. The multilayered sheet is cooled immediately upon entering the first nip. It is thereafter passed over a series of cooling rollers.

The multilayer sheet is also passed through a second nip downstream of the first nip. Both nips are formed by confronting rollers and are positioned to compress the multilayered sheet passing therethrough. In the preferred embodiment, the non-woven, spunbond polypropylene has a thickness of about 0.010″ and the second, extruded sheet of polypropylene has a thickness of about 0.020″ to 0.050″.

The second sheet is extruded onto the preformed sheet approximately 5″ from the first nip. The nip has a gap of approximately 0.025″ to 0.50″ and is formed between two chill rollers of between 150° F. and 180° F. and between 200° F. and 230° F., respectively. The second nip has a gap substantially similar to the gap at the first nip.

Other advantages and aspects of the present invention will become apparent upon reading the following description of the drawings and the detailed description of the invention.

### BRIEF DESCRIPTION OF THE DRAWINGS

Following are the brief descriptions and legends of the figures.

FIG. 1 is a schematic diagram of the process for making the multilayered sheets according to the teachings of the present invention;

FIG. 2 is a detail of a portion of the diagram shown in FIG. 1; and,

FIG. 3 is a schematic representation of the resultant, multi-layered product.

### DESCRIPTION OF THE INVENTION

While this invention is susceptible of embodiments in many different forms, there is shown in the drawings and will herein be described in detail, preferred embodiments of the invention with the understanding the present disclosure is to be considered as an exemplification of the principles of the invention and is not intended to limit the broad aspect of the invention to the embodiments illustrated. The present invention will have the following main components and techniques for operation of the device.

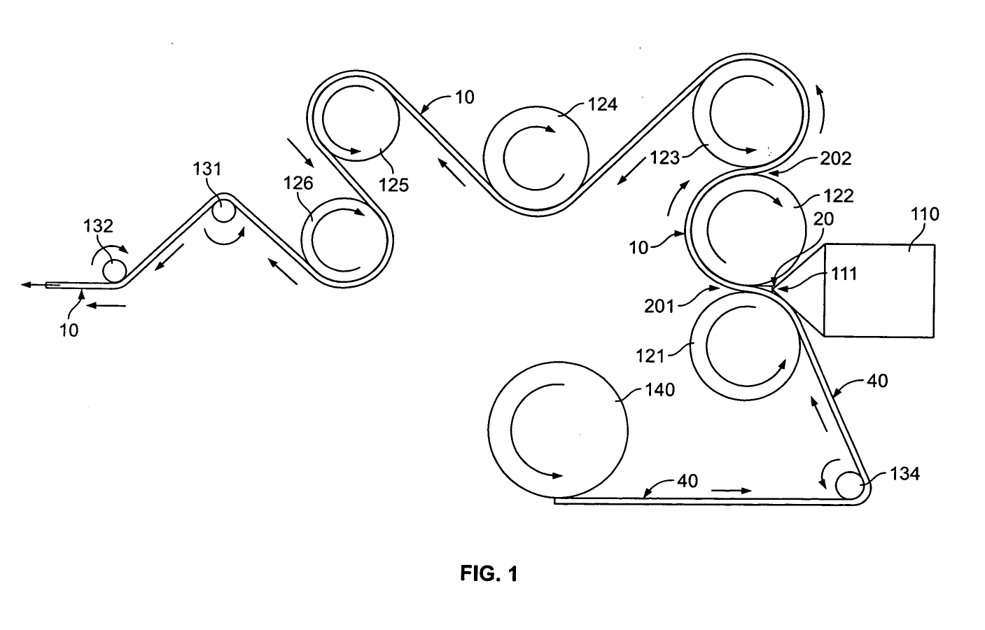

FIG. 1 shows a schematic representation of the process for making the multilayered sheet 10. An extruder 110 generally extrudes a sheet 20 of polypropylene through a die 111. The preferable die is about 72″ (width) by 9.5″ (height) by 11″ depth. The die lip opening is approximately 66″ wide, but it can be reduced or deckled so as to more closely match or align width-wise with the sheet it is being applied to or laid upon (discussed below). The extruded sheet's thickness can be varied depending upon the application and desired results. Thicknesses can range from 0.020″ and upwards. Specific thicknesses that have proved sufficient and adequate are 0.25″, 0.30″, 0.35″ and 0.40″. Widths range from about 40″ to about 58″. The lengths range from about 40″ and upwards. The extruded sheet 20 is passed through a series of nips 201,202 formed between a series of chill rollers 121,122,123 and passed over and partially around additional chill rollers 124,125,126 and idlers 131,132. In the preferred embodiment, the nip 201 is produced by confronting rollers 121,122. Roller 121 has a diameter of about 32″ and is maintained at a temperature of about 150° F. to about 180° F. while roller 122 has a diameter of about 32″ and is maintained at a temperature of about 200° F. to about 230° F. A second nip 202 is produced by confronting rollers 122,123. Roller 123 also has a diameter of about 32″ and is maintained at a temperature of about 200° F. to about 230° F. The chill rollers 124,125,126 123 are preferably sized and maintained to bring the temperature down towards room/ambient temperature.

A supply of non-woven, spunbond polypropylene 40 (in sheet form) is carried by a supply roller 140. The spunbond polypropylene is available from many suppliers. The spunbond polypropylene can be any width meeting a customer's demand or need, generally between about 40″ and 58″, and a thickness of various gauges. For example, a gauge spunbond of about 0.010 works well.

The making of spunbond fabrics is well-known in the industry. Such fabrics are used in many products today.

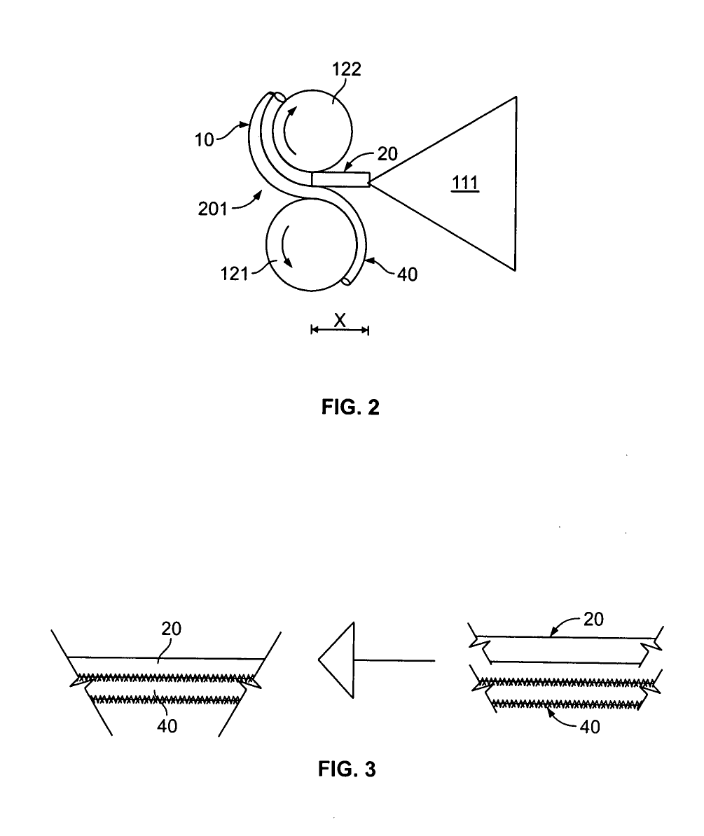

The non-woven sheet 40 is passed around one or more idlers 133,134 and fed into the first nip 201 downstream of the die 111 wherein it is forced into abutment with the extruded sheet 20. This specific area of the process is shown in further detail of FIG. 2.

The feeding of the non-woven-sheet 40 with the extruded sheet 20 occurs within inches of the extruder's die 111 and just before contacting the rollers 121,122 forming the nip. In this manner, it is believed, the extruded polypropylene 20 is bonded to the non-woven sheet 40 by a melding of fibers from the non-woven sheet 40 into the extruded sheet 20.

The first nip 201 has a clearance or opening sized to compress the multilayered sheet passing therethrough. The gauge or thickness depends on the end product desired. For example, for 0.025″ thick (gauge) multilayered sheets, the nip gap is set at about 0.030″; for 0.030″ thick sheets, the nip gap is set at about 0.035″, for sheets of 0.035″ and 0.040″ thick, the nip gap is set at about 0.040″ and 0.045″, respectively. The second nip gap 202 can be set similar to the first gap 201.

The above process and resulting product are very different from those in which the extrusion is extruded directly onto a substrate. Here, there is an intentional space (X in FIG. 2) between the die nozzle or lip 111 and the mating of the non-woven sheet 40 to the extruded sheet 20. That distance X has been found to be about 5 inches. The non-woven substrate 40 is carried by the bottom roller 121 to contact with the extruded sheet 20 and first nip 201.

The plastic exits the die's nozzle/lip 111 at about 450° F. and immediately cools down to about 340° F. The melting point of polypropylene is roughly 340° F. The two sheets 20,40 come together at the first nip 201 to form the combined (multilayered) sheet 10. The combined product goes through a controlled cool-down by passing around and over a series of chill rollers. Specifically, the chiller rollers 121, 122,123,124,125,126, generally 32″ diameter, are positioned to bring the temperature of the multilayered sheet 10 down in temperature. As noted, in practice, it has been found that chill rollers with the following temperatures work well: Roller 121 at approximately 150° F.-180° F.; Roller 122 at approximately 200° F.-230° F.; Roller 123 at approximately 200° F.-230° F. ; and, Rollers 124-126 at a moderate rate of cooling down towards room temperature (approximately 100° F.-150° F.).

The resultant product can be gauged so as to have a thickness of any desired or preferred amount. For example, successful gauges have been produced having a gauge of 0.025″, 0.030″, 0.035″ and 0.040″.

A test sample combining a non-woven polypropylene sheet (40) (2.0-3.0 oz/yd spunbond) of 0.013″ with an extruded polypropylene sheet (20) gauged at 0.025″. The resultant multi-layered sheet was measured at 0.030″. It is believed multilayered products of 0.025″-0.080″ would be typical. It is also believed that some melting occurs the in non-woven substrate 40 in the plane of intersection with the extruded sheet 20 (FIG. 3).

The results of the above process were extremely surprising to those investigating setting-up, running, and analyzing the above process and sheets. The resulting product was an extremely well-bonded multilayered sheet having strength and integrity with a “softer” side. The sheet is easily recyclable because no adhesive is used with the two layers of polypropylene. And, significantly, as compared to prior products, the above described product is less expensive to produce and arguably easier to make since adhesive is neither purchased nor incorporated in the manufacturing process. In addition, there is an inseparable bond between the non-woven sheet 40 and the extruded sheet 20. This resolves a common de-lamination problem associated with similar sheets bonded adhesively together.

It should be noted that while the extruded sheet 20 is shown and depicted as being substantially solid, it can also be an extruded corrugated plastic. The extruding of corrugated plastic sheets is known in the industry and can include internal hollows or channels between the outer surfaces of the sheets.

While the above process and resulting product were discussed broadly, it is recognized other variants can be made without deviating from the spirit of the invention. For example, other plastics, apart from polypropylene, can be used. The size, temperatures and number of the pressure rollers can be varied. In addition, other uses of the resultant product can be made.

We claim:

1. A method of making a multilayered sheet comprising the steps of:
feeding a preformed sheet to a nip so that the sheet passes therethrough;
extruding a second sheet onto the preformed sheet before the preformed sheet passes through the nip to form a multilayered sheet.

2. The method of claim 1 wherein the preformed sheet is a non-woven spunbond polypropylene sheet.

3. The method of claim 1 wherein the second sheet is a polypropylene.

4. The method of claim 1 further comprising the step of cooling the multilayered sheet after it passes through the nip.

5. The method of claim 4 wherein the step of cooling the multilayered sheet comprises passing the multilayered sheet over a series of cooling rollers.

6. The method of claim 5 further comprising the step of passing the multilayered sheet through a second nip downstream of the nip, both nips being positioned to compress the multilayered sheet passing therethrough and being formed by confronting rollers.

7. The method of claim 6 wherein:
the preformed sheet is a non-woven, spunbond polypropylene having a thickness of about 0.010″;
the second sheet is a polypropylene having a thickness of about 0.020″ to 0.050″;
the second sheet is extruded onto the preformed sheet approximately 5″ from the nip;
the nip has a gap of approximately 0.025″ to 0.50″ and is formed between two chill rollers of between 150° F. and 180° F. and between 200° F. and 230° F., respectively; and,
the second nip has a gap substantially similar to the gap at the nip.

8. A multilayered sheet having both strength and softness comprising:
a preformed first sheet;
a second sheet laminated to the first sheet, the second sheet being extruded onto the first sheet before both sheets are passed through a nip formed by confronting rollers.

9. The sheet of claim 8 wherein the first and second sheets are polypropylene.

10. The sheet of claim 9 wherein:
the preformed first sheet is a non-woven, spunbond polypropylene having a thickness of about 0.010″ and the second, extruded sheet is a polypropylene having a thickness of about 0.020″ to 0.050″.
